(19) United States
(12) Patent Application Publication
(10) Pub. No.: US 2006/0249210 A1
(43) Pub. Date: Nov. 9, 2006

(54) Pressure balanced dual seat three-way hydraulic valve

(75) Inventor: Cutis Lee Van Weelden, Waukesha, WI (US)

Correspondence Address: QUARLES & BRADY LLP, 411 E. WISCONSIN AVENUE, SUITE 2040, MILWAUKEE, WI, 53202-4497, US

(73) Assignee: HUSCO International, Inc.

(21) Appl. No.: 11/415,683

(22) Filed: May 2, 2006

Related U.S. Application Data
(60) Provisional application No. 60/677,124, filed on May 3, 2005.

(51) Int. Cl. F15B 13/044

(52) U.S. Cl. 137/625.65

(57) ABSTRACT

An electrohydraulic valve has a body with a pair of valve seats spaced apart in a bore. A valve element slides within the bore and has first and second end surfaces that selectively engage each valve seat to control fluid flow between a workport and each of an inlet port and an outlet port. The engagement of the valve element with the two valve seats is such that pressure from the workport is applied to substantially identical areas of the first and second end surfaces regardless of the position of the valve element in the bore. Thus the pressure forces exerted on both ends of the valve element balance each other, so that the only net forces producing movement of the valve element are from a spring and a solenoid.

### CROSS-REFERENCE TO RELATED APPLICATIONS

This application claims benefit of U.S. Provisional Patent Application No. 60/677,124 filed May 3, 2005.

### STATEMENT REGARDING FEDERALLY SPONSORED RESEARCH OR DEVELOPMENT

Not Applicable

### BACKGROUND OF THE INVENTION

1. Field of the Invention

The present invention relates to three-way, hydraulic poppet valves, and more particularly to such valves that are electrically operated.

2. Description of the Related Art

Three-way hydraulic valves are frequently used to route hydraulic fluid between a consumer device and alternately a source or a reservoir. In a first position of the valve, a first path is opened so that fluid is furnished from the source, such as a pump, to the consumer device. In a second valve position, a second path permits fluid to flow from the consumer device to a reservoir. In both positions of the valve, the other path is closed. It is desirable that the closed path be as low leakage as possible.

One of the design challenges is to minimize the effect that pressure variation has on the valve operation. Pressure acting on the valve may create a force imbalance that tends to move valve components in one direction more than in another direction. This force imbalance can produce unintended operation of the valve, or it may produce more or less resistance to valve component movement, thereby affecting the ability of a solenoid or other actuator to the operate the valve.

Therefore, it is desirable to minimize the effects that fluid pressure forces have on valve movement.

### SUMMARY OF THE INVENTION

A hydraulic valve has a body with a bore in which a valve element moves alternately between two valve seats. When the valve element engages a first valve seat, a path is opened between a first port and a workport connected to a fluid power consuming device. Inversely, when the valve element engages a second valve seat, another path is opened between a second port and the workport. Typically one port is connected to the output of a pump, while the other port is coupled to a reservoir that supplies fluid to the pump.

The surfaces of the valve seats and the surfaces of the valve element that engage the valve seats are contoured so that the workport pressure acts on equal surface areas at opposite ends of the valve element. This provides a balance and a cancellation of the forces exerted on the valve element due to the workport pressure. As a result, the magnitude and variation of that workport pressure has negligible affect on operation of the hydraulic valve.

The valve element is moved by an electrically operated actuator that preferably produces an electromagnetic field which induces motion of the valve element. In the preferred embodiment, the actuator is driven by a PWM signal which causes the valve element to oscillate between the two valve seats. The duty cycle of the PWM signal determines the amount of time that the valve element engages each valve seat and thus the amount of time that the workport is opened to each of the first and second ports. Therefore, the workport pressure is related to the duty cycle of the PWM signal and can be controlled by varying that duty cycle.

### BRIEF DESCRIPTION OF THE DRAWINGS

FIG. 1 is a top view of a novel hydraulic valve;

FIG. 2 is a cross-sectional view taken along line 2-2 in FIG. 1;

FIG. 3 is a side elevational view of the hydraulic valve;

FIG. 4 is an enlarged sectional view of a first seat in the hydraulic valve;

FIG. 5 is an enlarged sectional view of a second seat in the hydraulic valve; and

FIG. 6 is a diagram of a hydraulic system using the present valve.

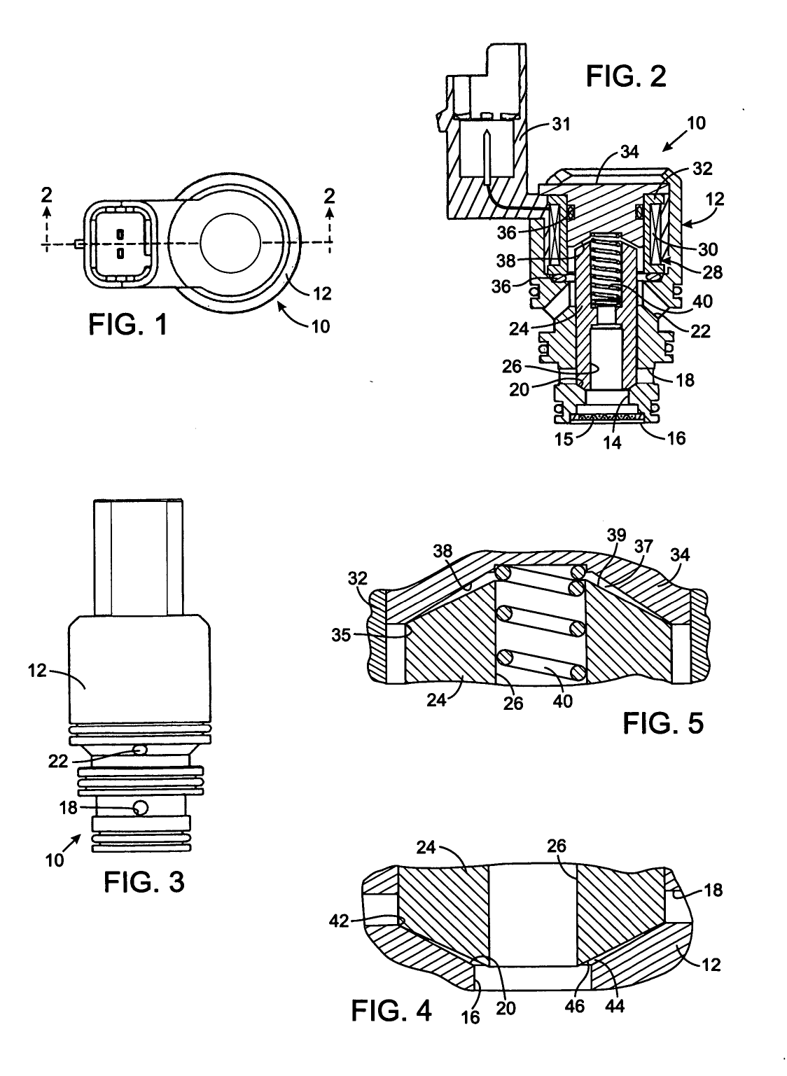

### DETAILED DESCRIPTION OF THE INVENTION

A hydraulic valve 10 has a metal body 12 with a circular bore 14 extending there through from one end to the other end. An opening at one end of the bore 14 forms a workport 16 for connection to a consumer device that receives hydraulic fluid from the valve. A disk-shaped filter 15 extends across the workport 16. A set of one or more axially extending apertures forms a first, or inlet, port 18 leading from the bore 14 through the body 12. A first valve seat 20 is located in the bore 14 between the workport 16 and the first port 18. Another set of apertures, which extend radially from the bore 14 on the opposite side of the first port 18 from the workport 16, form a second, or outlet, port 22.

A tubular valve element 24 has an aperture 26 extending there through and is slidably received within the bore 14. Also received within the bore is a solenoid actuator 28 with an electromagnetic coil 30 wound around an annular bobbin 32. A metal plug 34 extends into the opening of the annular bobbin 32. The inner surface of the plug 34 has a second valve seat 38 formed thereon and passage extends through the bore 14 from that inner surface to the second port 22. A rim at the remote end of the body 12 from the workport 16 is crimped over the plug 34 thereby closing the bore 14 at that remote end. An electrical connector 31 projects out of the body 12 from the actuator 28 and includes terminals for coupling the electromagnetic coil 30 to a control circuit. Sealing rings 36 provide fluid tights seals between the body 12 and the solenoid actuator 28 and between the bobbin 32 and the plug 34.

In the de-energized state of the actuator 28, a spring 40 biases the valve element 24 away from the plug 34 and into engagement with the first valve seat 20. That engagement closes communication between the workport 16 and the first port 18, blocking fluid from flowing there between. The valve element 24 in this position is away from the second valve seat 38, thereby opening a path from the workport 16 through the valve element aperture 26 and past the second valve seat 38 to the second port 22. In one application of this hydraulic valve 10, the de-energized state provides a path for fluid to flow from the workport 16 through the valve to the second port 22 which is connected to a tank return line of a hydraulic system. Thus fluid flows from the consumer device to the tank.

When electric current is applied to the solenoid actuator 28, a magnetic field is established by the electromagnetic coil 30 which overcomes the force of the spring 40 and draws the valve element 24 against the second valve seat 38 on the inner surface of the plug 34. This engagement of the second valve seat 38 closes the aperture 26 in the valve element 24, thereby blocking fluid flow there through between the workport 16 and the second port 22. At the same time, the valve element 24 is located away from the first valve seat 20, thereby opening a path between the workport 16 and the first port 18. In a common application of this valve, the energized state allows fluid to flow from a source connected to the first port 18 to the consumer device connected to the workport.

FIG. 4 is an enlarged view of the first valve seat 20. The contours of that valve seat 20 and of the mating surface on the adjacent end of the valve element 24 are such that the two components contact each other only at an annular line 42 at the outer circumference of the valve element. A gap 44 exists between the valve element 24 and the remainder of the valve seat 20 between that engagement line and the workport 16. Virtually the entire surface area 46 at the end of the valve element 24 is exposed to the pressure in the gap 44 from the workport 16 and that pressure exerts a force which tends to drive the valve element away from the first valve seat 20.

The identical, but inverted, surface configuration exists between the valve element 24 and the plug 34 at the second valve seat 38, as shown in FIG. 5. In other words, those surfaces engage only at an annular line 35 formed at the outer circumference at the upper end of the valve element 24. That circumferential engagement creates a gap 37 thereby exposing virtually the entire surface area 39 at the end at the upper end of the valve element to the pressure conveyed through the valve element aperture 26 from the workport 16. That workport pressure at the upper end exerts another force that tends to move the valve element away from the second valve seat 38. The gap 37 also provides an impedance to the magnetic flux, which inhibits residual magnetism from preventing the spring 40 from separating the valve element 24 from the plug 34 when the solenoid actuator 28 is de-energized.

Because only the outer circumferential lines at the ends of the valve element 24 engage the respective valve seat 20 or 38, the same surface area at each end is exposed to the workport pressure whether or not the valve element 24 is engaging or disengaging the valve seat. Therefore, regardless of the position of the valve element 24, the workport pressure acts on identically sized areas at the ends of the valve element 24. Consequently, equal but opposite forces are exerted at both ends of the valve element 24 by that workport pressure, thereby balancing each other. As a result of this balancing, the pressure at the workport produces a substantially zero net force on the valve element 24 and the operation of the valve element is unaffected by the magnitude and variation of the workport pressure. Thus the valve element moves only in response to the forces from the spring 40 and the magnetic field produced by the electromagnetic coil 30.

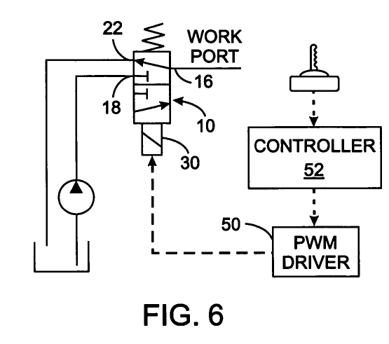

In one application of the hydraulic valve 10 shown in FIG. 6, the electromagnetic coil 30 is driven by a pulse width modulated (PWM) signal produced by a PWM circuit 50 in response to a command from a controller 52. The command activates and deactivates the PWM circuit 50 and specifies the duty cycle for the drive signal. For example, the PWM signal has a frequency of 60 Hz with a duty cycle that is altered to vary the magnitude of the pressure applied to the workport 16. The PWM signal results in the valve element 24 oscillating between the two valve seats 20 and 38 at the 60 Hz rate. The duty cycle of the PWM signal determines the amount of time during every signal cycle that the valve element 24 engages each valve seat 20 and 38. The greater the duty cycle, the longer the valve element 24 engages the second valve seat 38 which opens a path between the first port 18 and the workport 16. If that first port 18 is connected to a source of pressurized fluid, then the greater the duty cycle, the greater is the workport pressure.

The foregoing description was primarily directed to a preferred embodiment of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

1. An electrohydraulic valve comprising:
a body with a bore into which a first port, a second port and a workport open, a first valve seat in a flow path between the first port and the workport, and a second valve seat in another flow path between the second port and the workport;
a valve element moveably received within the bore, the valve element having a first surface that engages and disengages the first valve seat and having a second surface that engages and disengages the second valve seat, wherein pressure at the workport exerts substantially equal forces on both the first and second surfaces regardless of a position of the valve element within the bore; and
an electrically operated actuator that causes motion of the valve element between the first and second valve seats.

2. The electrohydraulic valve as recited in claim 1 wherein pressure from the workport is applied to a substantially identical amount of the first surface whether the first surface is engaging or disengaging the first valve seat, and pressure from the workport is applied to a substantially identical amount of the second surface whether the second surface is engaging or disengaging the second valve seat.

3. The electrohydraulic valve as recited in claim 1 wherein the electrically operated actuator produces a magnetic field that induces the motion of the valve element.

4. The electrohydraulic valve as recited in claim 1 further comprising a spring biasing the valve element toward one of the first and second valve seats.

5. The electrohydraulic valve as recited in claim 1 wherein the first valve seat is engaged by the valve element along substantially only an outer perimeter of the first surface.

6. The electrohydraulic valve as recited in claim 1 wherein the second valve seat is engaged by the valve element along substantially only an outer perimeter of the second surface.

7. The electrohydraulic valve as recited in claim 1 wherein the workport opens into a first end of the bore and both the first port and the second port open into the bore between the first end and an opposite second end.

8. The electrohydraulic valve as recited in claim 7 wherein the second valve seat is between the second port and the second end of the bore.

9. The electrohydraulic valve as recited in claim 7 wherein the valve element has an aperture extending between the first surface and the second surface.

10. An electrohydraulic valve comprising:
a body with a bore that has a first end and a second end, a workport opening into the first end, a first port opening into the bore with a first valve seat between the first port and the first end, a second port opening into the bore with a second valve seat between the second port and the second end;
a valve element moveably received within the bore, the valve element having a first surface that engages and disengages the first valve seat wherein pressure from the workport is applied to a substantially identical amount of the first surface whether the first surface is engaging or disengaging the first valve seat, and the valve element having a second surface that engages and disengages the second valve seat wherein pressure from the workport is applied to a substantially identical amount of the second surface whether the second surface is engaging or disengaging the second valve seat; and
an electrically operated actuator that causes motion of the valve element between the first and second valve seats.

11. The electrohydraulic valve as recited in claim 10 wherein pressure at the workport simultaneously acts on areas of the first and second surfaces which areas are of substantially equal size.

12. The electrohydraulic valve as recited in claim 10 wherein the valve element has an aperture extending between the first and second surfaces.

13. The electrohydraulic valve as recited in claim 10 wherein the electrically operated actuator produces a magnetic field that induces the motion of the valve element.

14. The electrohydraulic valve as recited in claim 10 further comprising a spring biasing the valve element toward one of the first and second valve seats.

15. The electrohydraulic valve as recited in claim 10 further comprising a spring biasing the valve element toward the first valve seat.

16. The electrohydraulic valve as recited in claim 10 wherein the first valve seat is engaged by the valve element along substantially only an outer perimeter of the first surface; and the second valve seat is engaged by the valve element along substantially only an outer perimeter of the second surface.

17. An electrohydraulic valve comprising:
a body with a bore having a first end and a second end, a workport opening into the first end, a first port opening into the bore with a first valve seat between the first port and the first end, a second port opening into the bore with a second valve seat between the second port and the second end;
a valve element moveable into different positions within the bore, the valve element having a first surface that engages and disengages the first valve seat and having a second surface that engages and disengages the second valve seat, wherein pressure at the workport exerts substantially equal forces on both the first and second surfaces regardless of the position of the valve element within the bore;
a spring biasing the valve element toward the first valve seat; and
an electrically operated actuator that produces a magnetic field which induces motion of the valve element between the first and second valve seats.

18. The electrohydraulic valve as recited in claim 17 wherein the first valve seat is engaged by the valve element along substantially only an outer perimeter of the first surface.

19. The electrohydraulic valve as recited in claim 17 wherein the second valve seat is engaged by the valve element along substantially only an outer perimeter of the second surface.

20. The electrohydraulic valve as recited in claim 17 wherein pressure from the workport is applied to a substantially identical amount of the first surface whether the first surface is engaging or disengaging the first valve seat, and pressure from the workport is applied to a substantially identical amount of the second surface whether the second surface is engaging or disengaging the second valve seat.
